(19) United States
(12) Patent Application Publication
(10) Pub. No.: US 2004/0118215 A1
(43) Pub. Date: Jun. 24, 2004

(54) Electromechanical apparatus with automatic self-test

(75) Inventors: Kelly J. Reasoner, Fort Collins, CO (US); Kraig A. Proehl, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX

(21) Appl. No.: 10/323,550

(22) Filed: Dec. 18, 2002

(51) Int. Cl. G01L 1/00

(52) U.S. Cl. 73/760

(57) ABSTRACT

An electromechanical locking apparatus comprises an attachment member, an actuator coupled to the attachment member and capable of extending the attachment member, an insertion member with an aperture for receiving the attachment member, and a sensor. The sensor is capable of detecting insertion member position. The attachment member has a configuration that moves the insertion member to deactivate and reactivate the sensor as the aperture receives the attachment member.

### BACKGROUND OF THE INVENTION

Data storage systems are used to store large volumes of information. As the quantity of information requiring storage continues to increase at unprecedented rates, predicting future storage needs and managing storage infrastructure costs are difficult problems. Accordingly, data storage systems use various techniques to regularly scale up capacity, throughput, and availability of data while reducing system downtime.

Some data storage systems store a plurality of data cartridges in slots within one or more drawers. Such data storage systems include media storage systems or autochangers to automatically change data cartridges in a cartridge reader in response to commands from a controller, enabling access to multiple data cartridges without having to manually position each cartridge in a reader. An autochanger may include one or more different types of cartridge-receiving devices capable of holding cartridges of different sizes and form factors.

These data storage systems include one or more storage racks or magazines arranged in drawers, rows, or other configurations that supply storage locations for the data cartridges. The data storage system commonly includes one or more cartridge read/write devices to access and store data on the cartridges. Although various operational modes are possible, systems commonly have the read/write device in a fixed location and use a moveable cartridge picker assembly to transport data cartridges between storage racks or magazines and the cartridge read/write devices. The cartridge picker can have a plunge mechanism that engages a data cartridge held within the rack or magazine and withdraws the data cartridge. The data storage system also can include a picker positioner that moves the cartridge picker assembly along the rack for transporting the cartridges between the read/write devices and the racks.

Data storage systems can have a controller, such as a host computer system, central processing unit (CPU), microcontroller, microprocessor, state machine, or other type of processor that manages data access and storage. The controller commonly controls functions of the read/write device and other operational elements of a data storage system.

For example, during operation the controller can issue a request for data contained on a particular data cartridge. A control system associated with the data storage system can actuate the picker positioner to move the picker assembly along the cartridge storage racks until positioned adjacent the selected cartridge. The control system then actuates the plunge mechanism to move the data cartridge from the storage rack to the picker assembly, and moves the picker assembly to a cartridge read/write device. Once properly positioned adjacent the read/write device, the plunge mechanism may insert the cartridge into the read/write device for reading or writing of data. When the operation is complete, the control system can actuate the plunge mechanism to remove the cartridge from the read/write device and return the cartridge to the appropriate location in the storage rack.

Some data storage systems may be configured as scaleable, modular units in which multiple autochanger modules, each having one or more read/write devices for example, can be connected to incrementally expand the total system storage capacity. In some configurations, multiple autochanger modules can be interconnected in a vertical stack. In a particular example, multiple autochanger modules may use a single picker assembly that can move vertically between the autochanger modules as well as horizontally within a single autochanger module. In this manner, the picker assembly may access a data cartridge from any autochanger module and access data from the cartridge from any read/write device in the stack of autochanger modules. Usage of a stack of autochanger modules increases total storage and the total number of cartridge read/write devices that can be simultaneously accessed.

In comparison to multiple individual autochangers connected over a network, a stacked autochanger configuration reduces cost since a multiple-module storage device can be made with a single picker mechanism and a single housing. Similarly, a controller can perform all management functions by addressing a single device rather than multiple devices, enabling all read/write devices in the stack access to any data cartridge from any level.

Various components in a data storage system have electromechanical locking devices for securing against unauthorized access and physical damage. For example, a data storage system may include electromechanical locks to lock one or more drawers in place within a chassis or storage cabinet. Some systems include electromechanical locks to lock a data cartridge in place within a slot. Some systems include electromechanical locks to secure a picker assembly in place in an autochanger module.

Some problems are that an electromechanical lock can be inoperative or damaged, and the inoperative character can be difficult to diagnose and detect. An actuator such as a solenoid or motor may not be connected or become disconnected, or the actuator or actuator circuitry can fail. Also service personnel can unplug and inadvertently fail to reconnect the actuator. The electromechanical locks are typically difficult to access so that operation cannot be easily verified without human intervention. An operator or user typically has no way to determine whether the actuator is correctly installed or correctly operating.

### SUMMARY OF THE INVENTION

In accordance with some embodiments, an electromechanical locking apparatus comprises an attachment member, an actuator coupled to the attachment member and capable of extending the attachment member, an insertion member with an aperture for receiving the attachment member, and a sensor. The sensor is capable of detecting insertion member position. The attachment member has a configuration that moves the insertion member to deactivate and reactivate the sensor as the aperture receives the attachment member.

In accordance with other embodiments, a method of operating a locking mechanism comprises sensing presence of a moveable member in a vicinity of a fixed structure and actuating a locking member in response to the moveable member sensed presence. The method further comprises engaging via the actuated locking member the moveable member with respect to the fixed structure and providing a configuration of the locking member so that the moveable member shifts position with respect to the fixed structure as the locking member is engaged. The method also comprises detecting the moveable member position shift.

In accordance with further embodiments, an electromechanical system comprises an actuator, for example a motor or solenoid, to advance a plunger that locks a device. In some examples, the plunger can lock an insertion member into place. The electromechanical system further comprises a sensor to detect and verify that the insertion member is locked in place. The plunger has an undulation, wave, curve, bend, or camber that functions as a sensor test apparatus so that, as the plunger is inserted into an aperture in the insertion member, the insertion member is moved with respect to the sensor. The plunger moves laterally to activate, then deactivate, and finally reactivate a signal from the sensor as the plunger is inserted. The electromechanical system further can include a controller that detects signals from the sensor including monitoring, and in some cases timing, the sequence of activation, deactivation, and reactivation. If any portion of the electromechanical system fails in the field, the controller can diagnose the error and generate an alert signal.

### BRIEF DESCRIPTION OF THE DRAWINGS

Embodiments of the invention relating to both structure and method of operation, may best be understood by referring to the following description and accompanying drawings.

FIGS. 1A, 1B, and 1D are schematic three-dimensional cut-away pictorial diagrams that illustrate an example of a media drawer lock assembly. FIG. 1C is a two-dimensional diagram that shows examples of configurations of a plunger that can be used with the media drawer lock assembly.

FIG. 2 is a three-dimensional partial-view pictorial diagram showing an example of positioning of the media drawer lock assembly in a chassis or housing of a media storage module.

FIGS. 3A, 3B, 3C, and 3D are cross-sectional pictorial diagrams that show an example of an arrangement of the media drawer lock assembly as a plunger is deployed.

FIG. 4 is a flow chart that illustrates an embodiment for controlling a locking mechanism and simultaneously testing components of the locking mechanism.

FIG. 5 is a schematic three-dimensional pictorial diagram showing an example of a media storage module that can be used in a media storage library system.

FIG. 6 is a pictorial diagram showing a frontal view of a front panel display that is suitable for usage in a media storage library system.

FIG. 7 is a pictorial diagram showing a frontal view of a status bar that can be shown on various screens.

FIG. 8 is a three-dimensional pictorial diagram that shows an example of a multiple-module media storage library system.

### DETAILED DESCRIPTION

What are desired are an apparatus and method that facilitate automatic self-testing and diagnosis without operator interaction.

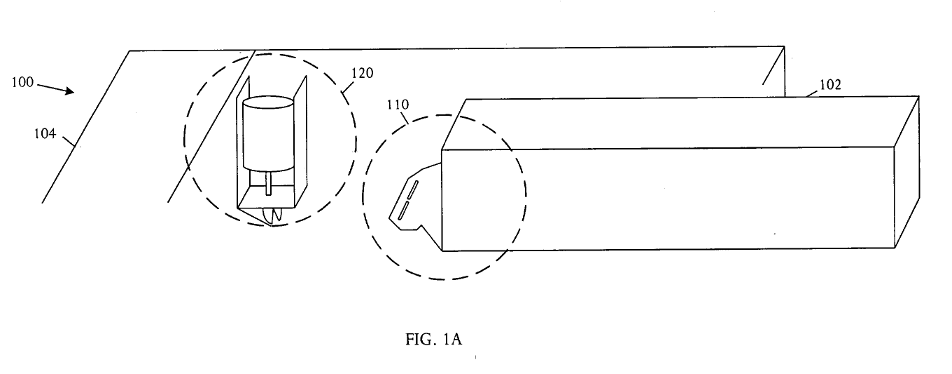

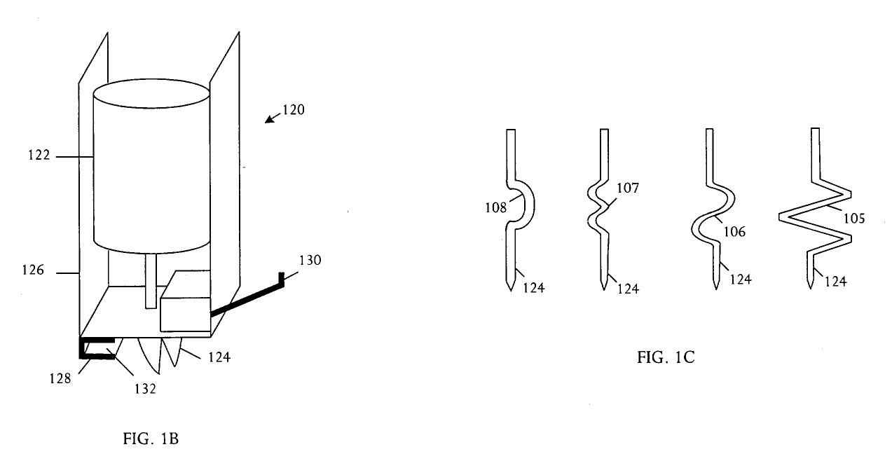

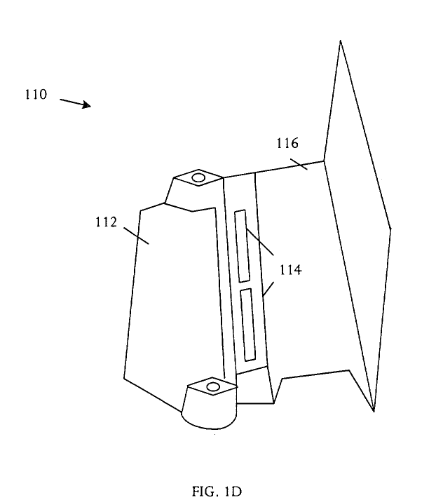

Referring to FIGS. 1A, 1B, and 1D, schematic three-dimensional cut-away pictorial diagrams illustrate an example of a media drawer lock assembly 100. The illustrative media drawer lock assembly 100 shown in FIG. 1A comprises a media drawer attachment segment 110 and a housing attachment segment 120. The media drawer attachment segment 110 comprises a plunger insertion member 112 with an aperture 114, and a drawer attachment member 116 that firmly affixes the plunger insertion member 112 to a media drawer 102. The housing attachment segment 120 comprises a plunger drive element 122 with a plunger 124, a plunger drive attachment member 126 that firmly affixes the plunger drive element 122 to a housing 104. The housing attachment segment 120 also comprises a sensing arm 130 and a sensor 128 that couple to the plunger drive attachment member 126.

The sensing arm 130 senses when the moveable media drawer 102 is reaching a closed position in the fixed cabinet, for example by detecting contact with the plunger insertion member 112 as the plunger insertion member 112 is entering an insertion channel 132. The sensing arm 130, typically a mechanical sensor, actuates the plunger drive element 122 to extend the plunger 124.

When the media drawer 102 is in a lock position, the plunger insertion member 112 is seated to an insertion channel 132 in the plunger drive attachment member 126 and is detectable by the sensor 128. The sensor 128 is any suitable type of sensor capable of detecting positioning of the plunger insertion member 112 within the insertion channel 132. One suitable type of sensor 128 is an optical sensor or optical interrupter sensor.

The illustrative media drawer attachment segment 110, shown in FIG. 1D, is constructed as an extension of the media drawer 102. For example, the media drawer 102 can be constructed from plastic and the media drawer attachment segment 110 can be molded as a member that extends from a posterior surface of the media drawer 102. In other embodiments, the media drawer 102 and media drawer attachment segment 110 can be constructed from the same material or different materials. Typical materials that are suitable for the media drawer 102 and the media drawer attachment segment 110 include plastics, metals, or any other suitable solid materials. The illustrative media drawer attachment segment 110 has an aperture 114 in the plunger insertion member 112 that is constructed as apertures in a molded plastic frame. The apertures 114 can be machined or drilled into the plunger insertion member 112 as well as molded for various plastic, metal, or other compositions. The aperture 114 can be a single aperture or multiple apertures, and can have any suitable shape or configuration. The illustrative aperture 114 includes two substantially straight-line holes in a collinear configuration. In other embodiments, one or more holes may be used as the aperture 114 in any suitable shape, size, or configuration.

The illustrative housing attachment segment 120, illustrated in FIG. 1B, comprises a plunger drive attachment member 126 firmly affixed to the housing 104. The plunger drive attachment member 126 firmly affixes the plunger drive element 122 that controls and drives motion of the plunger 124. The plunger drive element 122 is any suitable drive element that is capable of moving and controlling motion of the plunger 124. In various embodiments, the plunger drive element 122 can be a solenoid, motor, or any other device capable of controllably moving the plunger 124. Suitable solenoids include C-frame, D-frame, push-pull, tubular, and other solenoids. Typically, a linear solenoid can be used that converts electrical energy into a linear mechanical motion to move the plunger 124 a specified distance. Current flow through a solenoid coil winding creates a magnetic field, producing an attraction between the moveable plunger and a stop. On application of electrical power, the solenoid's plunger and an external load on the plunger accelerate and move toward the solenoid's stop until impact. The plunger rides inside the coil core, typically either a plastic bobbin or a nonmagnetic metallic guide. Removal of power from the solenoid eliminates current flow in the coil and the external load returns to a rest position, aided by a return force such as a return spring, gravity, or the external load.

Referring to FIG. 1C, multiple two-dimensional diagrams show examples of configurations of a plunger that can be used with the media drawer lock assembly. The plunger 124 can take any suitable form, for example a zigzag 105, a wave 106, an undulation 107, a bend 108, or other forms. The plunger 124 can be constructed from any suitable material for articulating with the aperture 114 in the plunger insertion member 112. In some embodiments, the plunger 124 can be a rod or multiple rods. In other embodiments such as the illustrative embodiment, the plunger 124 has the form of a fork. Illustratively, the plunger 124 can be a two-pronged fork extending as two substantially collinear blades. The blades can have any suitable geometry, for example extending to pointed ends, a flat surface, or other forms. The plunger 124 can be constructed from any suitable material, for example plastic, metal, or other compositions.

In the illustrative media drawer lock assembly 100, the plunger 124 includes a wave 106, curve or bend 108, undulation 107, zigzag 105, or other suitable configuration generally in the anterior-posterior direction. The configuration causes the media drawer 102 and the media drawer attachment segment 110 to move in and out one or more times when the plunger 124 inserts into aperture 114 of the plunger insertion member 112. The sensor 128 detects the brief displacement, facilitating testing of the media drawer lock assembly 100 including testing of the plunger drive element 122 the sensor 128 while the media drawer 102 is simultaneously locking.

In various embodiments, the shape, geometry, and configuration of the plunger 124 and the aperture 114 in the plunger insertion member 112 can be selected or varied to attain smooth locking and sensing operation. For example, sides of the aperture 114 can be contoured or slanted to assist entry of the plunger 124 into the aperture 114 through the wave, curve, or bend 108 in the plunger 124.

The electromechanical system tests functionality of the sensor and/or the actuator, while simultaneously locking a mechanism. The electromechanical system tests operation of the actuator, such as a motor or solenoid, without human interaction. The electromechanical system also tests operation of the actuator and the sensor whenever the lock is engaged, not simply a single test during manufacturing test.

The electromechanical system automatically verifies that the actuator is assembled and functions correctly, and that the sensor is assembled and functions correctly, without human interaction. The electromechanical system automatically tests that the electromechanical lock functions correctly at every operation of the actuator to engage the lock.

The electromechanical system uses the sensor and actuator that is already within a locking system to perform test operations with minor modifications.

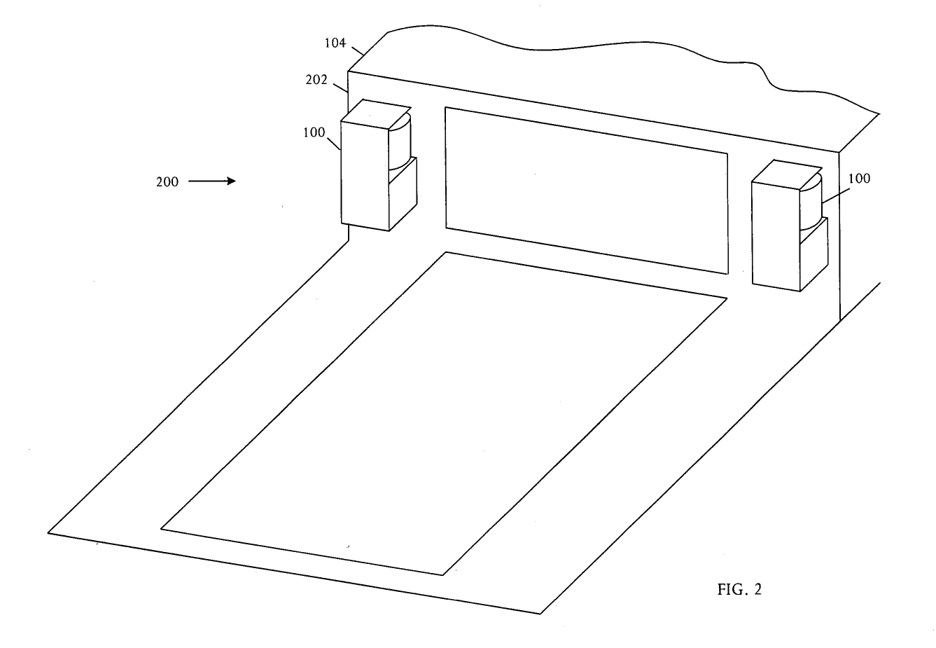

Referring to FIG. 2, a three-dimensional partial-view pictorial diagram shows an example of positioning of the media drawer lock assembly 100 in a chassis or housing 104 of a media storage module 200. The media storage module 200 includes two media drawer lock assemblies 100 for left and right drawers affixed at a rear panel 202 of the chassis 104.

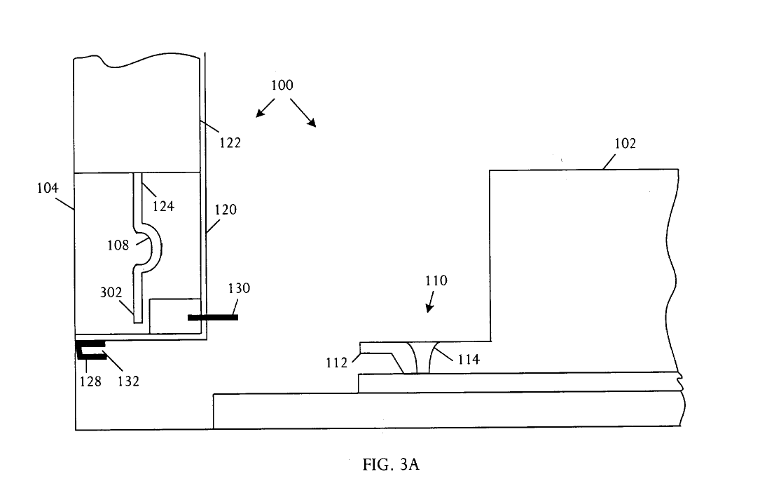

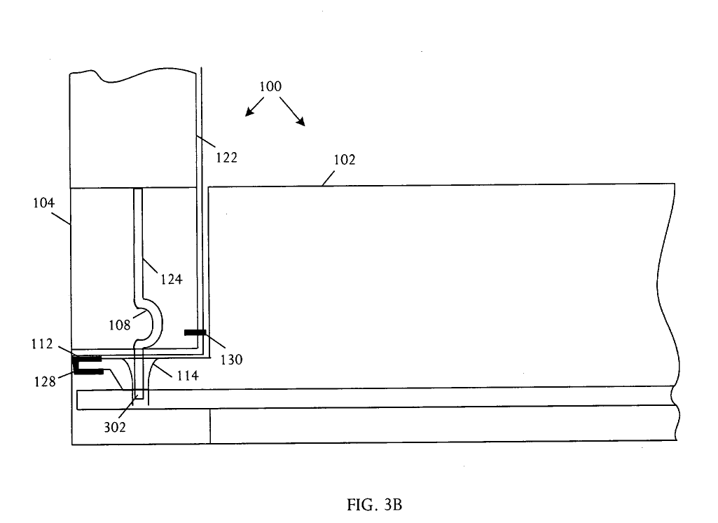

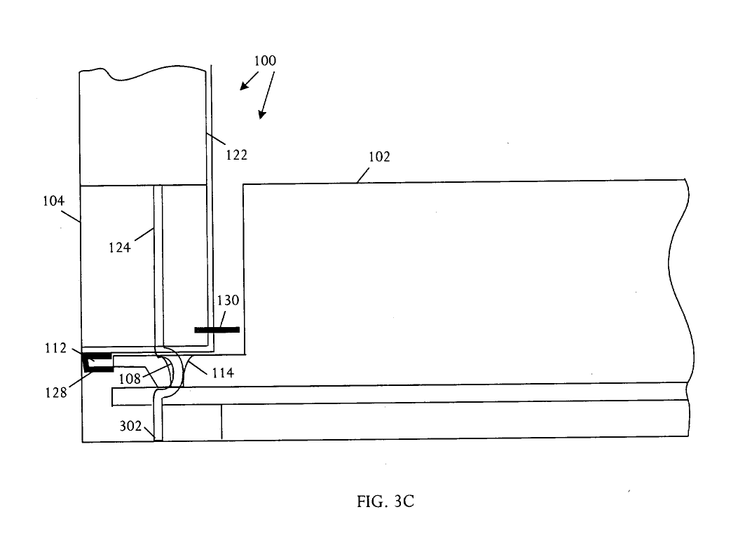

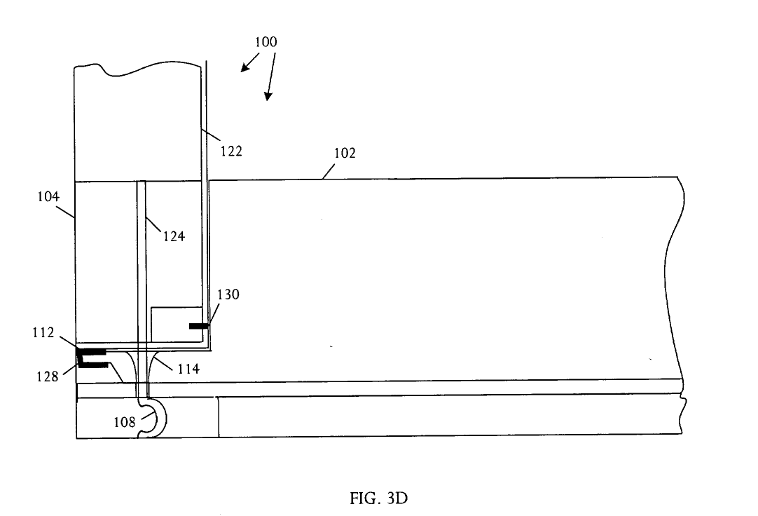

Referring to FIGS. 3A, 3B, 3C, and 3D, a media drawer 102 is pushed into the chassis 104 showing the media drawer lock assembly 100 during deployment of the plunger 124. FIG. 3A shows a media storage module 700 with a media drawer 102 partially or fully withdrawn from the chassis 104. The media drawer attachment segment 110 and plunger insertion member 112 are fully removed from the housing attachment segment 120 and plunger 124. A user or operator typically actuates a key or button on a front panel display of the storage system to unlock and withdraw the media drawer 102 to the illustrative position. The media drawer 102 can be withdrawn a controlled distance, for example opening to access at least one data cartridge in a mailslot access.

As shown in FIG. 3B, the media drawer 102 is in the process of closing and automatically locking. In some embodiments, the media drawer 102 nears a closed position within the chassis 104 and the sensing arm 130 contacts the plunger insertion member 112, activating a controller to cause the plunger drive element 122 to begin extending the plunger 124. In other embodiments, the sensing arm 130 may be omitted and the controller can enter a polling routine that monitors the sensor 128 to determine whether the plunger insertion member 112 in nearing a seated position. In either case, the controller then monitors the sensor 128 to determine positioning of the plunger insertion member 112.

The controller activates the plunger drive element 122 when the media drawer 102 enters close to a seated position within the chassis 104. The plunger drive element 122 can have a spring (not shown) that returns the plunger drive element 122 to an open position and release the media drawer 102 upon entry of an open command to the front panel or when power is turned off. When power is removed, all plunger drive elements 122 can be released, opening all media drawers 102 in a default steady state.

Movement of the media drawer 102 toward a locking position positions the plunger insertion member 112 roughly in the vicinity of a seated position. Actuating the plunger drive element 122 to fire the plunger 124, forcing the plunger 124 into the aperture 114 rigidly places the media drawer 102 to a stable, centered position within the chassis 104. Rigid positioning of the media drawer 102 is highly beneficial to enable smooth operation of a robotic assembly that moves media cartridges within the system.

The plunger 124 begins entering the aperture 114, for example in the manner of entering a funnel arrangement to facilitate firm seating of the plunger insertion member 112 into the insertion channel 130. The distal portion 302 of the plunger 124 contacts the aperture 114 causing the plunger insertion member 112 to be disposed within the sensor 128. The sensor 128 detects the plunger insertion member 112 and sends a signal to the controller indicating that the media drawer 102 has entered the close position.

Referring to FIG. 3C, the plunger 124 extends further into the aperture 114 to the position of the wave, curve, or bend 108 in the plunger 124, momentarily pulling the plunger insertion member 112 away from the sensor 128. The signal from the sensor 128 indicating the momentarily open sensor 128 transfers to the controller.

In FIG. 3D, the plunger 124 is fully deployed into the aperture 114, beyond the position of the wave, curve, or bend 108 so that the plunger insertion member 112 is pulled back into the sensor 128. The sensor signal to the controller verifies the locked condition.

The media drawer lock assembly 100 is an electromechanical system that uses an electromechanical lock to secure a media drawer 102, a door, or other assembly, and a sensor 128 to detect status of the lock. The electromechanical lock has a sensor test apparatus that momentarily activates, then deactivates, then activates the sensor 128 for simultaneously testing of the sensor 128 and the electromechanical lock as the lock is deployed. The media drawer lock assembly 100 further includes a control element that detects and monitors the activation, deactivation, and activation sequence to formulate a test response.

In one example, the sensor test apparatus is implemented as an undulation, wave, curve, bend or camber in a lock plunger 124, and the control element detects and times the sensor response sequence to determine efficacy of the lock.

The media drawer lock assembly 100 comprises the plunger drive element 122, an actuator such as a motor or solenoid, to advance a plunger 124 that locks a device such as the media drawer 102. In some examples, the plunger 124 can lock an insertion member 112 into place. The media drawer lock assembly 100 further comprises a sensor 128 to detect and verify that the insertion member 112 is locked in place. The plunger 124 has an undulation, wave, curve, bend, or camber that functions as a sensor test apparatus so that, as the plunger is inserted into an aperture in the insertion member 112, the insertion member 112 is moved with respect to the sensor 128. The plunger 124 moves laterally to activate, then deactivate, and finally reactivate a signal from the sensor 128 as the plunger is inserted. The media drawer lock assembly 100 further can include a controller that detects signals from the sensor 128 including monitoring, and in some cases timing, the sequence of activation, deactivation, and reactivation. If any portion of the media drawer lock assembly 100 fails in the field, the controller can diagnose the error and generate an alert signal.

Accordingly, the media drawer lock assembly 100 tests functionality of the sensor 128 and/or the plunger drive element 122, while simultaneously locking a mechanism. The media drawer lock assembly 100 tests operation of the plunger drive element 122, such as an actuator, motor or solenoid, without human interaction. The media drawer lock assembly 100 can also test operation of the plunger drive element 122 and the sensor 128 whenever the lock is engaged, not simply a single test during manufacturing.

The media drawer lock assembly 100 can automatically verify that the plunger drive element 122 is properly assembled and properly functions, and that the sensor 128 is correctly assembled and functions without human interaction. The media drawer lock assembly 100 can automatically test that the electromechanical lock correctly functions at every operation of the plunger drive element 122 to engage the lock.

When the media drawer 102 is closed and locked, the controller reinventories the media drawer 102 to determine any changes in media. For example, a robotic assembly can use imaging technology to locate and view bar codes on the data cartridges and identify media characteristics.

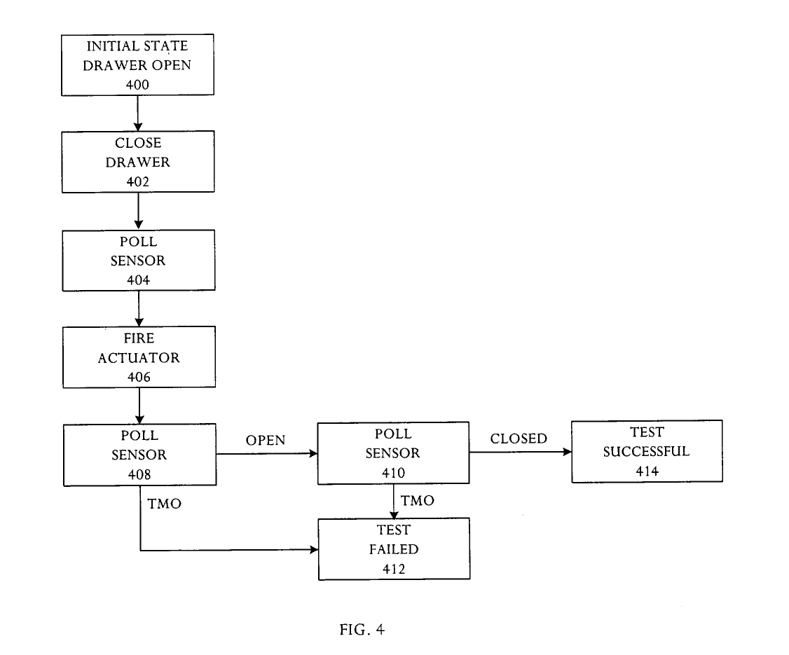

Referring to FIG. 4, a flow chart illustrates an embodiment for controlling a locking mechanism and simultaneously testing components of the locking mechanism. The method, process, or procedure is typically executed by a controller or processor contained within a storage system or disposed external to the storage system but in communication with the system. In one example, a media storage module within a media storage library system may include a library controller that can execute the technique.

In an initial state 400 drawer or door to a storage module is in an open configuration with the plunger drive element 122, for example a solenoid, in a released state. A user activates the method by closing the drawer or door 402, for example by physically pressing the drawer or door into a closed position. In other embodiments, a user may close a drawer or door by pressing a button on or near the door, pressing a key on a front panel or possibly entering a command, and the like. The system can poll 404 a sensing mechanism such as the sensor 128 or respond to activation of a sensing mechanism such as the sensing arm 130 to detect drawer closure. The controller responds to closure detection by activating 406 the plunger drive element 122, for example a solenoid, and entering a polling loop 408 that waits for subsequent detection in change in state of the sensor 128.

If the sensor changes state, the controller enters a second polling loop 410 to wait for sensor closure. If a timer times out (TMO) before the sensor opens, the controller enters an error handling action 412. The first and second polling loops 408 and 410 time closing, opening, and subsequent closing of the sensor 128 to determine whether the plunger drive element 122 is correctly functioning, and also to detect some types of sensor failure.

The controller enters the error handling action 412 upon timeout of a selected interval, typically on the order of a fraction of a second up to a few seconds, to determine whether a sensor actuates within a reasonable time and, if not, to flag an error condition. The error handling action 412 verifies whether the plunger drive element 122 properly activates and deactivates, and can indicate whether the sensor 128 fails to operate upon drawer or door closure. For example, after initial actuation of the plunger drive element 122, failure to detect a change in state of the sensor 128 may indicate that the sensor 128 is not properly functioning. The error condition may otherwise indicate that the plunger drive element 122 did not properly activate and an appropriate error code can be displayed on the storage system front panel to assist trouble-shooting.

When an error condition occurs, the controller can attempt one or more subsequent test cycles upon occurrence of a timeout failure to account for transient conditions, such as system jostling or movement.

If the sensor successfully closes in the second polling loop 410, the controller can set a flag indicating proper operation 414 of the plunger drive element 122 and sensor 128 that permits the system to continue operation, for example permitting robotic or automatic control operations. Robotic or automatic control operations risk system damage to robotic mechanisms if the plunger drive element 122 is not correctly operating. A successful test indicates that the plunger drive element 122 is properly connected, the system is properly locking, and the door is shut and locked.

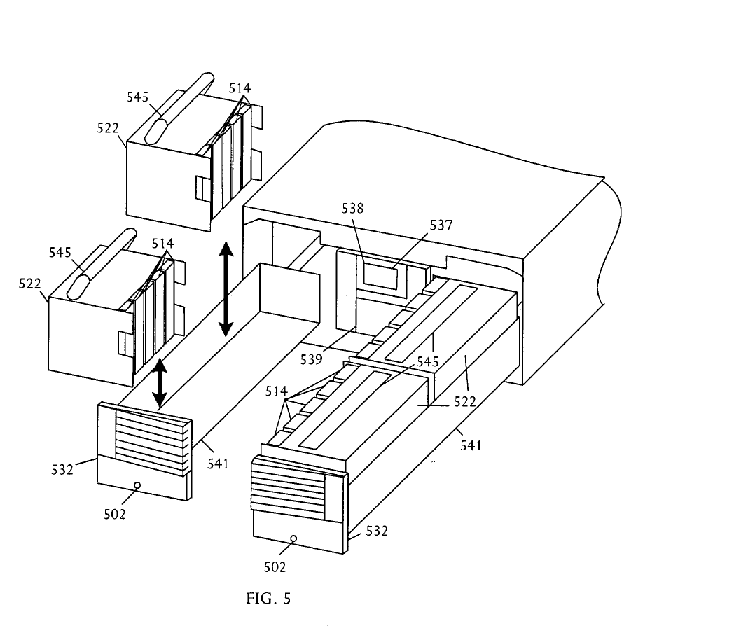

Referring to FIG. 5, in the illustrative media storage library system a user can access data cartridges 514 via magazine access or mailslot access. In either case, the user accesses the data cartridges 514 through a door 532 on a front panel 538. The illustrative media storage module 500 has two doors 532 on adjacent sides of a window on the front panel 538. The window may be a display panel window 537 or a viewing window 539. The cartridge magazines 522 are held within media drawers 541 on opposite sides of a guide frame that are accessible when the doors 532 are open. The front panel 538 has a user interface that includes soft keys and a front panel light emitting diode (LED). The doors 532 have a lock 502.

In a magazine access operation, a user actuates buttons on a menu displayed on the display panel window 537 to unlock one or more doors, then draw out the unlocked drawer(s) to access cartridge magazines 522 and data cartridges 514. In some applications, media drawers 541 may be key-locked so that the user unlocks the media drawer 541. The user removes a cartridge magazine 522 by lifting vertically with a magazine handle 545, and removes a data cartridge 514 by lifting from the cartridge magazine 522. The user may insert the same or another data cartridge 514 back into the cartridge magazine 522. In some embodiments, the media drawers 541 move in and out of the media storage module 500 under the power of a drawer transport mechanism (not shown) as controlled by buttons on the display panel window 537. In other embodiments, the drawers can be manually removed and inserted via sliding drawers.

In a mailslot access operation, a user actuates buttons on the menu displayed on the display panel window 537 to show a “mailslot access” screen that displays a message indicating the number of data cartridges 514 in the mailslot and the procedure for opening the appropriate door 532. Actuation of a “open drawer” button causes the media drawer 541 to open only to the number of storage slots that have been configured for the mailslot. The user may insert, withdraw, or replace data cartridges 514 in the mailslot, then close the media drawer 541. The media storage library system automatically detects the closure, locks the media drawer 541, and initiates an inventory check.

In normal operation, the doors 532 and media drawers 541 are locked, and a user can access a selected data cartridge 514 either locally from the display panel window 537 or remotely via commands from a controller. The controller may be a local controller 510 connected to or contained within the media storage library system or a remote controller accessing via a network. The picker 516 can access all data cartridges 514 contained within the media storage module 500 and within a media storage library system with multiple media storage modules 500. If a user desires to remove a data cartridge 514 from a cartridge read/write device 524, for example for replacement, the user can control the picker 516 to move the cartridge from the cartridge read/write device 524 to a cartridge magazine 522. For magazine access, the user can move the cartridge to a selected media drawer 541. For mailslot access, the user moves the cartridge to a magazine and location within the magazine that is configured as the mailslot. When the cartridge is appropriately positioned, the user can access the cartridge by magazine access or mailslot access for removal or replacement.

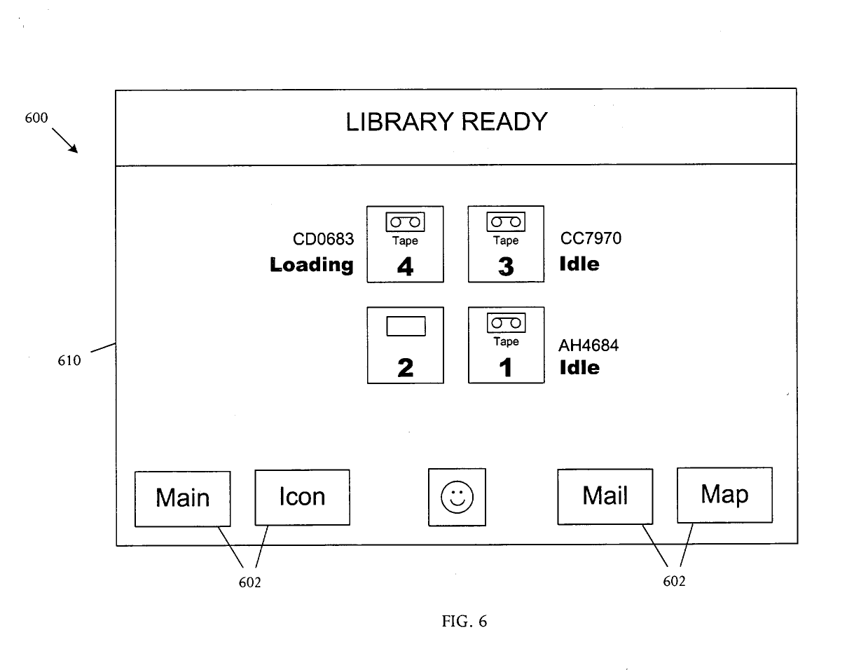

Referring to FIG. 6, a pictorial diagram shows a frontal view of a front panel display 600 that is suitable for usage in a media storage library system. In an illustrative example, the front panel display 600 can be a liquid crystal display with a plurality of soft keys. The front panel display can be used to display status of self-test operations. The front panel display 600 mounts on the front of the media storage library and functions as a user interface that controls library functions. The front panel display 600 displays icons and text showing library, drive, and data cartridge status information. Displayed text prompts and warnings direct user operations while accessing the media storage library system.

The front panel display 600 may have multiple status light-emitting diodes (LEDs) that communicate status and error conditions in real-time. The LEDs can be used to display error information regarding operation of the solenoid and/or sensors.

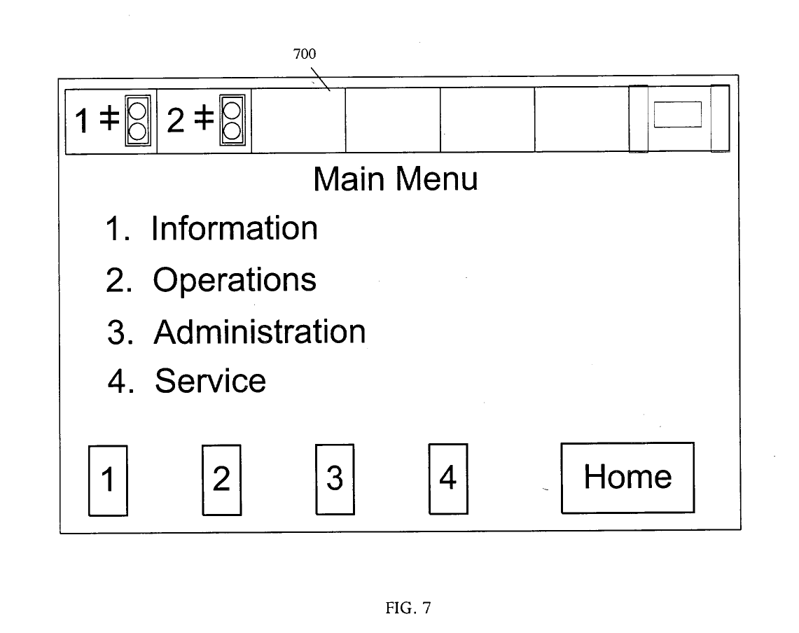

Referring to FIG. 7, a pictorial diagram shows a frontal view of a status bar 700 that can be shown on various screens. In some examples, the status bar 700 can be displayed on all screens except Home and Map screens. The status bar 700 summarizes library and drive status and can reverse color for drive or library errors that have been entered in a media log or hard error log. Drive icons can show results of locking component self-tests. Drive icons can also show conditions such as power-off, offline, failure-offline, needs cleaning, cleaning in progress, empty, loading, write-protected media, online, full and idle, unloading, seeking data, writing data, rewinding for tape media, reading data, erasing, and others. Library icons can show conditions such as failed, partially available, and operational. Other icons, assigned as drive icons or library icons, or otherwise configured under another category of icons, can be defined to alert a user to status and conditions of components in a locking system. For example, icons can be configured and displayed to indicate status of sensors and actuators such as solenoids or motors, and to identify the particular device such as drawer, robotic, media slot, and the like,

Error types include soft or recovered errors, partial availability errors, system and media errors, and hard or unrecovered errors. A soft error is recovered or resolved by one or more automatic retries. The soft error log returns a message indicating the absence of soft errors or supplies an error entry or history. An error light on the front panel may display solid green for a soft error.

A partial availability error indicates the library has a condition to be noted but remains operational. The error light on the front panel may display solid amber for a partial availability error. Partial availability conditions include drive conditions such as drive not present, offline, online pending, firmware mismatch, dirty, critical error, and Fibre channel conditions. Other partial availability conditions include magazine and mailslot conditions such as missing or incompatible magazines, open doors, or an open mailslot. Other partial availability conditions are front panel conditions including failure of front panel display power-up and failure to detect the front panel.

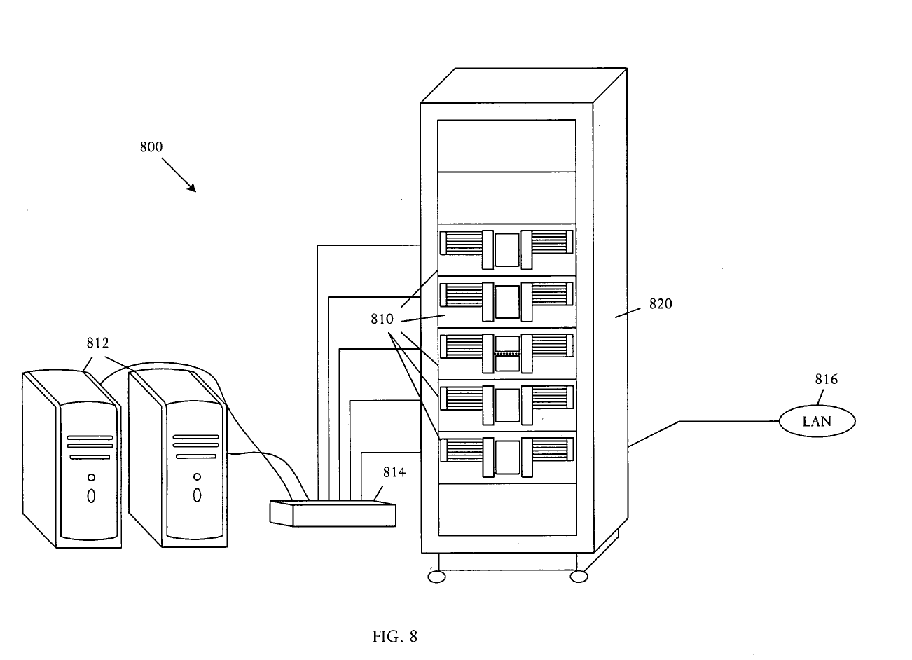

Referring to FIG. 8, a three-dimensional pictorial diagram shows an example of a multiple-module media storage library system 800. The media storage library system 800 may include processors and controllers interior to a particular storage module, interior to multiple-module system but shared among modules, and external to the system to control functions such as self-test functions. The illustrative media storage library system 800 has a large capacity cabinet 820 that can hold multiple media storage modules 810 in a large capacity media storage library system 800. The media storage library system 800 comprises, in addition to the cabinet 820 and the multiple media storage modules 810, one or more host processors 812 that are connected to the cabinet 820 via a hub or switch 814. The media storage library system 800 may also include a remote management card local area network (LAN) connection 816 for remote access and storage of data. The hub or switch 814 and the LAN connection 816 are connected to the media storage modules 810 in the cabinet 820 by any suitable interface, such as a small computer systems interface (SCSI). A host processor 812 can operate as a system controller or other suitable processor for controlling and managing testing and configuration operations of the media storage library system 800.

Although the illustrative example describes a system for testing the lock and sensor for locking of a drawer into a cabinet or chassis, the same or similar apparatus and method can be employed to lock other components or devices including but not limited to locking of a slot in a drawer, locking of a robotic component or device to a fixed position in a housing, chassis, or cabinet, or the like.

What is claimed is:

1. An electromechanical locking apparatus comprising:
an attachment member;
an actuator coupled to the attachment member and capable of extending the attachment member;
an insertion member with an aperture for receiving the attachment member; and
a sensor capable of detecting position of the insertion member, the attachment member having a configuration that moves the insertion member to deactivate and reactivate the sensor as the aperture receives the attachment member.

2. An apparatus according to claim 1 further comprising:
a controller coupled to the sensor and capable of executing a process that tests operability of the actuator and/or the sensor.

3. An apparatus according to claim 1 further comprising:
a controller coupled to the sensor and capable of monitoring activation and deactivation of the sensor and generating a test response in response to the monitored activation and deactivation.

4. An apparatus according to claim 1 wherein:
the apparatus tests one or more components of a locking system while simultaneously locking a device.

5. An apparatus according to claim 1 wherein:
the attachment member is a plunger and the actuator is a solenoid that actuates to extend the plunger into the aperture in the insertion member.

6. An apparatus according to claim 1 wherein:
the attachment member is a plunger that has a curve, bend, or undulation capable of shifting the insertion member with respect to the sensor as the plunger extends into the aperture.

7. An apparatus according to claim 1 wherein:
the sensor is an optical sensor.

8. An apparatus according to claim 1 wherein:
the actuator is selected from among a group including a motor and solenoid that are capable of advancing a plunger to lock a device.

9. An apparatus according to claim 1 wherein:
the attachment member and the sensor operate in combination to activate, deactivate, and reactivate a signal as the actuator advances the attachment member to lock a device.

10. An apparatus according to claim 1 further comprising:
a storage chassis;
at least one storage module installed within the storage chassis, the storage modules including one or more of a group comprising a door, a drawer, a storage cartridge slot, a robotic engaging assembly, and a robotic assembly.

11. An apparatus according to claim 1 wherein:
the locking apparatus locks a device selected from among the group comprising the door, the drawer, the storage cartridge slot, the robotic engaging assembly, and the robotic assembly.

12. A method of operating a locking mechanism comprising:
sensing presence of a moveable member in a vicinity near a fixed structure;
actuating a locking member in response to the moveable member sensed presence;
engaging via the actuated locking member the moveable member with respect to the fixed structure;
shifting position of the moveable member with respect to the fixed structure as the locking member is engaged; and
detecting the moveable member position shift.

13. A method according to claim 12 further comprising:
configuring the locking member so that the moveable member shifts position with respect to the fixed structure as the locking member is engaged.

14. A method according to claim 13 further comprising:
sensing the moveable member in the vicinity of the fixed structure as a first portion of the locking member configuration is engaged.

15. A method according to claim 14 further comprising:
detecting the moveable member position shift away from the fixed structure as a second portion of the locking member configuration is engaged.

16. A method according to claim 15 further comprising:
sensing presence of the moveable member back toward the fixed structure as a third portion of the locking member configuration is engaged.

17. A method according to claim 12 further comprising:
initiating timing in response to the moveable member sensed presence;
timing for a predetermined interval; and
generating an error signal if the predetermined interval times out before the moveable member position shift away from the fixed structure is detected.

18. A method according to claim 12 further comprising:
initiating timing in response to detection of the moveable member position shift away from the fixed structure;
timing for a predetermined interval; and
generating an error signal if the predetermined interval times out before sensing presence of the moveable member shifting back toward the fixed structure.

19. A method according to claim 12 further comprising:
sensing presence of a moveable member in a vicinity of a fixed structure using optical sensing.

20. A method according to claim 12 further comprising:
sensing initial presence of a moveable member in a vicinity of a fixed structure using mechanical sensing; and
sensing subsequent position of the moveable member using optical sensing.

21. A method according to claim 12 further comprising:
centering via the actuated locking member the moveable member with respect to the fixed structure.

22. A method according to claim 12 further comprising:
testing the locking mechanism automatically when the moveable member is in the vicinity near the fixed structure.

23. A locking apparatus capable of locking a moveable member to a fixed structure comprising:
means for locking the moveable member to the fixed structure, the locking means having a configuration that shifts position of the moveable member with respect to the fixed structure;
means for sensing presence of the moveable member in a vicinity near the fixed structure;
means responsive to the sensing means for actuating the locking means;
means for engaging the moveable member to the fixed structure with the locking means;
means for shifting position of the moveable member with respect to the fixed structure while engaging the locking means; and
means for detecting the moveable member position shift.

24. A locking apparatus according to claim 23 further comprising:
means for monitoring sensing of the moveable member in the vicinity of the fixed structure in a first portion of the locking means configuration;
means for monitoring detection of the moveable member position shift away from the fixed structure as the locking means is engaged in a second portion of the locking means configuration; and
means for monitoring sensing movement of the moveable member back toward the fixed structure in third portion of the locking means configuration.

25. A locking apparatus according to claim 23 further comprising:
means for initiating timing in response to the moveable member sensed presence;
means for timing for a predetermined interval; and
means for generating an error signal if the predetermined interval times out before the moveable member position shift away from the fixed structure is detected.
